(19) United States
(12) Patent Application Publication
(10) Pub. No.: US 2017/0106473 A1
(43) Pub. Date: Apr. 20, 2017

(54) PRESSURE VESSEL

(71) Applicants: ROLLS-ROYCE plc, London (GB); ROLLS-ROYCE POWER ENGINEERING PLC, Derby (GB)

(72) Inventors: Steven P LAWLER, Burton on Trent (GB); Daniel CLARK, Derby (GB); Clive GRAFTON-REED, Leicester (GB); Keith BRIDGER, Rotherham (GB)

(73) Assignees: ROLLS-ROYCE plc, London (GB); ROLLS-ROYCE POWER ENGINEERING PLC, Derby (GB)

(21) Appl. No.: 15/288,957

(22) Filed: Oct. 7, 2016

(30) Foreign Application Priority Data
Oct. 16, 2015 (GB) 1518351.0

(51) Int. Cl. B23K 26/34; G21C 13/02; B23K 26/08; B23K 26/144; B23K 26/16

(52) U.S. Cl. CPC B23K 26/34; B23K 26/144; B23K 26/16; B23K 26/0876; G21C 13/02; G21Y 2004/201

(57) ABSTRACT

A pressure vessel having a diameter greater than or equal to 1 m and made by laser cladding an inner surface of the vessel, the laser cladding following a helical path.

### TECHNICAL FIELD

The present disclosure concerns a pressure vessel and/or a method of cladding a pressure vessel.

### BACKGROUND

Nuclear pressure vessels (e.g. reactor vessels) are generally large components, for example a typical pressure vessel would have a diameter in the region of at least 2 metres. A pressure vessel typically has a cylindrical central portion and domed ends (which may be referred to as heads). The pressure vessels are generally made from a low-carbon steel. To withstand the harsh environment of operation, the inner surface of the vessel needs to be coated with an inert material, for example with stainless steel or a nickel-based alloy.

Arc welding techniques such as metal inert gas (MIG) or tungsten inert gas (TIG) welding is used to coat the inner surface of the pressure vessels. The arc welding process introduces a high thermal input into the substrate (i.e. the material of the vessel being coated). This high thermal input means that the clad and substrate chemistries mix resulting in a diluted clad material on the inner surface of the vessel. To address this, multiple layers of clad material are deposited on the inner surface of the vessel. Each layer of clad needs to be individually inspected using a suitable non-destructive technique to ensure that no defects are present before welding the next layer of clad. Furthermore, it is typically necessary to machine the clad material once it has been deposited to achieve the required surface finish and chemistry suitable of the operational environment (e.g. high temperature and high pressure). This method of cladding a component is time consuming and expensive.

### SUMMARY

According to a first aspect there is provided a method of cladding a pressure vessel having an internal diameter (e.g. at the widest part) greater than or equal to 1 m (e.g. greater than or equal to 2 m). The method comprises laser cladding an inner surface of the vessel, wherein the laser cladding follows a helical path.

The helical path may be defined such that adjacent loops of clad overlap by approximately 40 to 70%, e.g. 60%.

The method may comprise rotating and axially moving the vessel to define the helical path.

Alternatively, a head of the cladding machine may be manipulated to define the helical path. Further alternatively, the head and the vessel may be manipulated to define the helical path, for example the vessel may be rotated and the head may be moved axially.

The method may comprise positioning a vessel on a support frame. The support frame may comprise rollers arranged to manipulate the vessel (e.g. to rotate and/or axially move the vessel).

The vessel may not be pre-heated before being clad. For example, just before (or at the start) of the cladding process the temperature of the vessel may be considered to be at room temperature (e.g. 10 to 40° C.).

The method may comprise providing a metallic powder, melting said powder, and depositing said powder on the inner surface of the vessel.

Alternatively the source of cladding material used to clad the internal surface may be a wire.

The method may comprise using a vacuum to remove excess powder from the vessel.

The method may comprise providing a powder removal device to generate the vacuum. The device may comprise a housing and a plurality of holes. The device may be configured such that excess powder is removed via the holes and is directed to a location removed from the vessel.

Once the inner surface of the component has been clad, the method may comprise moving a laser over the surface of the component to reduce the surface roughness. The laser may be the laser used to clad the vessel.

The method may comprise adding additional insulation to a head of the laser cladding equipment used to clad the vessel.

The vessel may be a cylinder having a length greater than or equal to approximately 1 m. Alternatively, the vessel may be dome shaped.

According to a second aspect there is provided a method of producing a pressure vessel for use in a nuclear power generation plant, the method comprising providing a vessel, and cladding the vessel using the method according to the first aspect.

The pressure vessel may be a reactor vessel or a heat exchanger.

According to a third aspect there is provided a pressure vessel made by the method according to the second aspect.

According to a fourth aspect there is provided a method of cladding a pressure vessel having an internal diameter (e.g. at the widest part) greater than or equal to 1 m (e.g. greater than or equal to 2 m). The method comprises providing the vessel at room temperature; and laser cladding an inner surface of the vessel.

That is, the method does not comprise the step of pre-heating the vessel before laser cladding.

The vessel may be a vessel for a nuclear power plant, e.g. a reactor or a heat exchanger.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a schematic of a nuclear power plant;

FIG. 2 is a schematic cross section of a reactor vessel of the power plant of FIG. 1;

FIG. 3 is a schematic of equipment used to clad a vessel;

FIG. 4 is a schematic cross-section of a nozzle of a head of the equipment of FIG. 3;

FIG. 5 is a schematic perspective view of a powder removal device;

FIG. 6 is a plan view of a clad inner surface of the vessel of FIG. 2; and

FIG. 7 is a schematic plan view of a section of three passes of cladding of the clad surface of FIG. 6.

### DETAILED DESCRIPTION

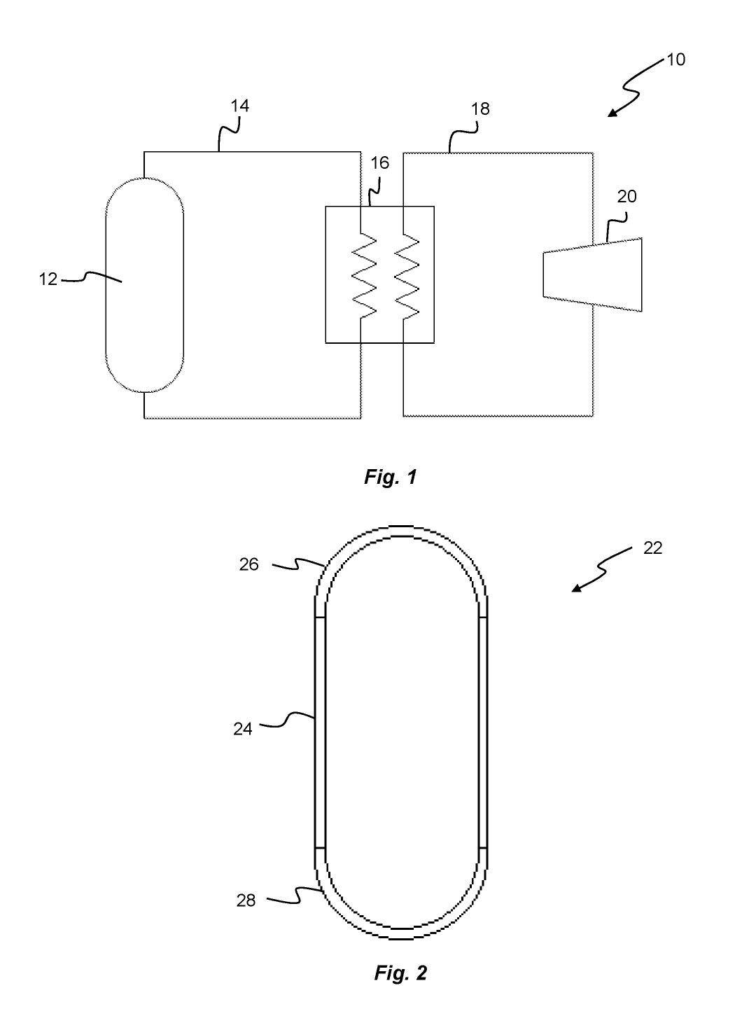

Referring to FIG. 1, a nuclear power plant is indicated generally at 10. The plant includes a nuclear reactor 12, a primary circuit 14, a heat exchanger 16, a secondary circuit 18 and a turbine 20. The primary fluid in the primary circuit is heated by the nuclear reactor. The primary fluid then flows to the heat exchanger, where it heats secondary fluid in the secondary circuit. The heated secondary fluid is then used to drive the turbine 20.

Referring to FIG. 2, a pressure vessel for use in the nuclear reactor 12 or heat exchanger 16 is indicated generally at 22. The vessel 22 is fabricated from 3 parts individually manufactured; a cylindrical section 24, and two domes 26, 28, one dome being provided at each longitudinal end of the cylindrical section. In the present example, the cylindrical section is welded to the two domes. The diameter of the cylindrical section is equal to or greater than 2 m (and as such the maximum diameter of the dome sections is greater than or equal to 2 m), and the length of the cylindrical section is greater than or equal to 1 m.

The pressure vessel in this example is made from a low-carbon steel and has a coating of stainless steel on the inner (or internal) surface of the vessel. In alternative embodiments the inner surface of the pressure vessel may be coated with a nickel-based alloy.

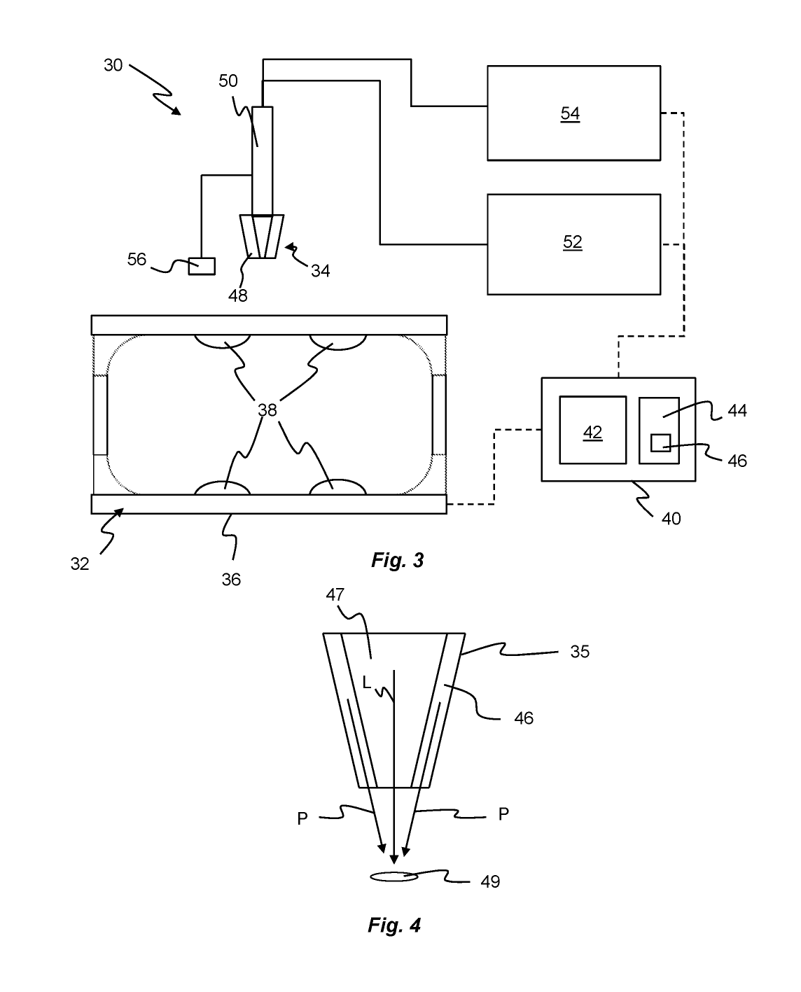

Referring now to FIGS. 3 and 4, equipment for use in applying the coating to the inner surface of the vessel will now be described. The equipment 30 includes a vessel support 32 and a cladding machine that includes a head 34.

The vessel support 32 includes a frame 36 and a plurality of rollers 38. The frame 36 supports the vessel to maintain the vessel in the desired position. The rollers 38 are arranged so that they are able to manipulate the vessel, including rotating the vessel. The vessel support 32 may be connected to a control unit 40. The control unit 40 may be used to control the manipulation of the vessel via the support vessel and/or the operation of the cladding machine.

The control unit 40 may comprise any suitable circuitry to cause performance of the methods described herein. The control unit may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller, to perform the methods.

By way of an example, the control unit 40 may comprise at least one processor 42 and at least one memory 44. The memory 44 may store a computer program 46 comprising computer readable instructions that, when read by the processor 40, causes performance of the methods described herein. The computer program may be software or firmware, or may be a combination of software and firmware.

The processor 40 may include at least one microprocessor and may comprise a single core processor, or may comprise multiple processor cores (such as a dual core processor or a quad core processor).

The memory 44 may be any suitable non-transitory computer readable storage medium, data storage device or devices, and may comprise a hard disk and/or solid state memory (such as flash memory). The memory 44 may be permanent non-removable memory, or may be removable memory (such as a universal serial bus (USB) flash drive).

The cladding machine is of the type commercially available and includes a head 34 that applies the cladding to the surface of a component. Referring to FIG. 4, the head includes a nozzle 35 that has an annular powder outlet 46 and a portion 47 that directs a laser beam towards the surface of a component. The focal point 49 of the powder and the laser beam is substantially the same. The powder is made from the cladding material. Arrows P indicate the general direction of flow of powder from the nozzle and arrow L indicates the general direction of the laser beam.

Referring again to FIG. 3, the head 34 is insulated by insulation 48, in this case protective sheaths and aluminium foil, to insulate the components of the head and to reflect any heat away from the head. The heat may be present as a result of reflections of the laser beam from the internal surface of the vessel.

The head 34 is connected to a manipulator 50. The manipulator may include a jib or a column. In some examples the manipulator includes an articulated arm that may be connected to either a jib or column.

A powder supply 52 is provided. In this example the powder supply is remote from the head. Flexible piping is used to transport powder from the powder supply to the head.

A laser source 54 is provided. In this example, the laser source is remote from the head. Optical cables are used to transmit the laser beam to the component via the head 34.

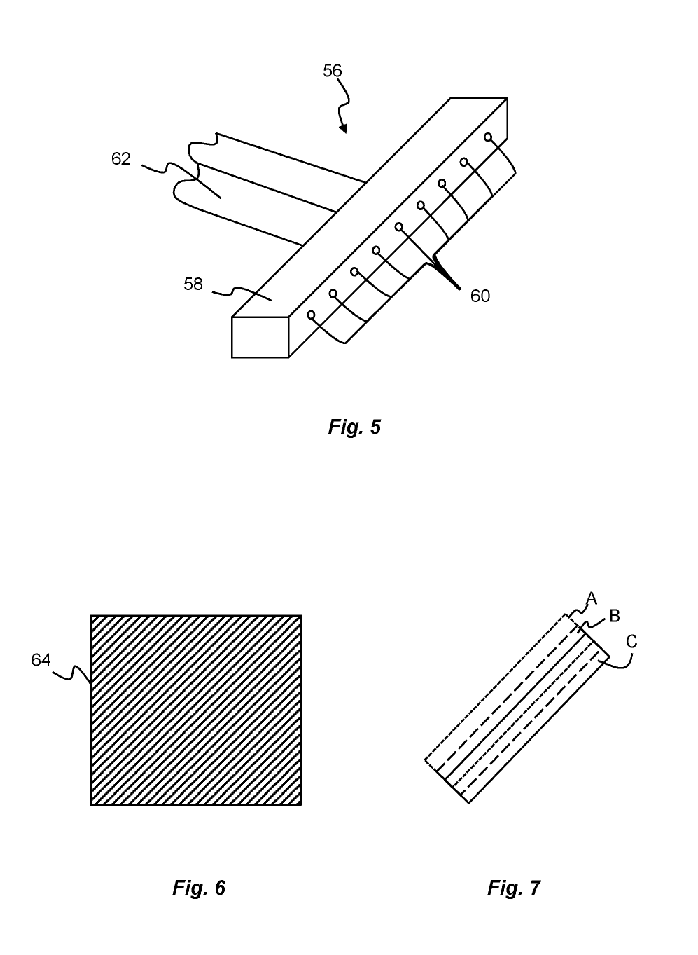

A powder removal device 56 is also provided. Referring to FIG. 5, the powder removal device is a powder handling vacuum, in the current example, the removal device includes a housing 58 and with a plurality of holes 60 provided therein. The removal device is connected to a suction source via a pipe 62.

The method of cladding the cylindrical part 24 of the vessel 22 (shown in FIG. 2) will now be described.

The cylindrical part 24 of the vessel 22 is positioned on the vessel support 32. When the cylindrical part is position on the vessel it is at room temperature. No heat treatment of the component takes place. The inventors have surprisingly found that the vessel does not need heating before the laser cladding process, e.g. using the following described method, without the need to preheat. This is contrary to what is currently done in the art, and goes against the prejudice in the art.

Once the part 24 is in position, the head 34 is moved to a start position that is inside the bore of the cylindrical part 24. The cladding process is then commenced.

During the cladding process, metal powder is blown through the nozzle 45 along the annular passageway 46 by an inert gas, e.g. argon. A laser beam is fired through the central portion 47 of the nozzle. The laser beam melts the metal powder whilst it is in transit to the substrate to be clad, this means that the majority of the powder is heated (and molten) before it reaches the surface of the cylindrical part 24, the remainder of the powder is melted on the surface.

In the present example, the powder spot has a diameter of approximately 1 cm, but it will be understood by the person skilled in the art that the diameter of the powder spot can vary depending on the set up of the cladding machine and the specific arrangement of the nozzle.

During the cladding process, the vessel support 32 rotates the cylindrical part and moves the cylindrical part axially, in this way a helix of cladding is deposited on the inner surface of the cylindrical part, as illustrated in FIG. 6 which shows a portion 64 of the clad surface of the cylindrical part. The cylindrical part is moved such that each pass of cladding overlaps the previous pass by 40 to 70%, e.g. 60%, as illustrated in FIG. 7. In FIG. 7, the overlap of the passes is greater than 50% and a second pass B (outline indicated by long dashed line) is shown overlapping a first pass A (outline indicated by short dashed line), and a third pass C (outline indicated by solid line) is shown overlapping both the first pass A and the second pass B by differing extents.

During the cladding process, the powder removal device is used to remove any loose powder from the inner side of the cylindrical part. For example, this may be powder that has not been melted and has fallen from an upper surface of the cylindrical part to a lower surface of the cylindrical part as the cylindrical part is rotated.

The laser cladding process may take place in a single run, or alternatively, for larger components the laser cladding process may be done in several stages. Generally if using welding techniques it is undesirable to start and stop the cladding process, but when laser cladding is used, the point at which the stop-start occurs is not unacceptably affected because the process means that there will always be more material at the point of the restart. Furthermore, during the overlap of the restart position (due to each pass of cladding deposit overlapping) the heat from the laser has been found to smooth the cladding in the stop-start region.

It has been found that optionally the laser of the head 34 can be run over the cladding once cladding has been completed. In this way the clad surface can be smoothed. However, the surface finish of the laser cladding is smoother than a comparable welded clad surface and as such for some applications no surface post-processing (such as smoothing with a laser or machining) may be necessary.

The size the cylindrical part is much greater and cladding of the internal surface is more complex that parts from other industries that are clad using laser cladding.

For example, the size of the component means that the cladding process is in continuous operation for a longer period of time than for other components. In addition to the size of the component, cladding of the internal surface of the component also poses technical challenges because of laser reflections, heat management, and powder nozzle blockages. The present inventors have found that it has been possible to overcome these challenges using the described method.

Laser cladding of the inner surface of the pressure vessel is advantageous over conventional processes such as TIG and MIG welding because not as much heat is put into the surface, which means that dilution is significantly reduced. In some examples, it is expected that dilution could reach less than 4%. This means that only a single layer of cladding needs to be provided, compared to the multiple layers of the prior art. Use of only a single layer of cladding means that process time can be reduced both in terms of production and inspection. Furthermore, the laser clad surface does not need machining, saving more production time.

Cladding along a helical path reduces the number of stop-starts compared to other cladding patterns that could be used. Furthermore, cladding along a helical path means that the temperature of the parent material (the cylindrical part) is more consistent at the point where the cladding is deposited, compared to other options of cladding paths. The process “sees” the parent material as an infinite heat sink which means that the dilution is more consistent. Furthermore, there is a steady state inter-pass temperature which helps to reduce cracking.

Removing the need for preheating large components such as the described pressure vessel before cladding means that manufacturing times can be reduced and the capital costs involved in manufacturing large pressure vessels for nuclear power plants can be reduced.

Adding additional insulation to the head further helps with heat management and reduces blockages in the nozzle.

The method of cladding a pressure vessel has been described with reference to the cylindrical part, but it will be appreciated that a similar method could be used to clad the dome ends of the pressure vessel.

One example of laser cladding has been described, but other laser cladding equipment may be used and in this alternative equipment the features of the head may be different and/or wire may be used as the source material instead of powder.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of cladding a pressure vessel having an internal diameter greater than or equal to 1 m, the method comprising:
laser cladding an inner surface of the vessel, wherein the laser cladding follows a helical path.

2. The method according to claim 1, wherein the helical path is defined such that adjacent loops of clad overlap by 40 to 70%.

3. The method according to claim 1, comprising rotating and/or axially moving the vessel to define the helical path.

4. The method according to claim 1, wherein the vessel is not pre-heated before being clad.

5. The method according to claim 1, wherein the method comprise providing a metallic powder, melting said powder, and depositing said powder on the inner surface of the vessel.

6. The method according to 5, comprising using a vacuum to remove excess powder from the vessel.

7. The method according to claim 1 comprising, once the inner surface of the component has been clad, moving a laser over the surface of the component to reduce the surface roughness.

8. The method according to claim 1, comprising adding additional insulation to a head of laser cladding equipment used to clad the vessel.

9. The method according to claim 1, wherein the vessel is a cylinder having a length greater than or equal to approximately 1 m.

10. A method of producing a pressure vessel for use in a nuclear power generation plant, the method comprising:
providing a vessel; and
cladding the vessel using the method according to claim 1.

11. A pressure vessel made by the method according to claim 10.

12. A method of cladding a pressure vessel having an internal diameter greater than or equal to 1 m, the method comprising:
providing the vessel at room temperature; and
laser cladding an inner surface of the vessel without pre-heating the vessel.

13. The method according to claim 12, wherein the vessel is a vessel for a nuclear power plant.
